(19) United States
(12) Patent Application Publication
(10) Pub. No.: US 2008/0283732 A1
(43) Pub. Date: Nov. 20, 2008

(54) Optical Potentiometer with Temperature Drift Compensation

(75) Inventors: Hans-Gunther Rosenkranz, Wantirna South (AU); Mark Frederick Armstrong, Victoria (AU); James Russell, Packenham (AU); Peter John Major, Richmond (AU)

Correspondence Address: BROMBERG & SUNSTEIN LLP, 125 SUMMER STREET, BOSTON, MA, 02110-1618, US

(73) Assignee: AIMBRIDGE PTY LTD, Melbourne (AU)

(21) Appl. No.: 12/091,654

(22) PCT Filed: Oct. 10, 2006
(86) PCT No.: PCT/AU2006/001487

§ 371 Date: Jun. 16, 2008

(30) Foreign Application Priority Data
Oct. 28, 2005 (AU) 2005905994

(51) Int. Cl. G01D 5/26

(52) U.S. Cl. 250/214 PR

(57) ABSTRACT

A potentiometer is disclosed which comprises an opaque screen element (10) and light emitters and collectors (92) for transmitting light through the screen and detecting the light transmitted through the screen. The screen has three sections (A, V and B). The sections (A, V and B) have bars which are parallel to one another and extend transverse to the direction of movement of the screen (10). The section (A) has bars which are arranged in groups comprising the same number of bars, but each of a different thickness. The section (V) has two parts (35, 36), the first part has bars which are formed in the same manner as the section (A) except they are a mirror image to the bars in section (A) and each group comprises less bars than are in the groups in section (A). The second part of section (V) has individual bars which increase in thickness. Section (B) is a mirror image of section (A). This configuration allows for any drifting of voltage indicative of a change in light intensity which is detected by the emitter to be identified and compensated for because the intensity of light passing through the sections and plotted against position forms a U or V-shaped profile, with the apex identifying the maximum or minimum light intensity and therefore voltage at the collector.

### FIELD OF THE INVENTION

This invention relates to a potentiometer and, in particular, but not exclusively, to a potentiometer for a control lever assembly for use in boats. The invention is an improvement to the potentiometer disclosed in our International Patent Application No. PCT/AU2005/001608 and corresponding Australian Provisional Patent Application Nos. 2004907143 and 2005904019. The contents of these applications are incorporated into this specification by this reference.

### BACKGROUND OF THE INVENTION

As explained in the above International application, conventional potentiometers generally comprise variable resistors. These types of potentiometers do suffer from a number of problems. The invention in our above International application provides an optical potentiometer which addresses the disadvantages of potentiometers which comprise variable resistors.

The potentiometer disclosed in our International application does operate extremely well but there is still room for further improvement in relation to the sensitivity of the potentiometer and the manner in which redundancy is provided to ensure that the potentiometer continues to operate.

### SUMMARY OF THE INVENTION

The present invention, in a first aspect, may be said to reside in a potentiometer comprising:
a light emitter device;
a light collector device;
a screen element located between the emitter device and collector device for movement relative to the emitter device and collector device;
the screen element having at least a first section and a second section;
the first section allowing the amount of light which can pass through the first section to change from a first location of the first section to a second location of the first section; and
the second section having a first part and a second part, the first part allowing the amount of light which can pass through the first part to change from a first location of the second section to an intermediate location of the second section, and the second part allowing the amount of light which can pass through the second part to change from the intermediate location to a second location of the second part, the change in the amount of light which can pass through the first part, varying from a first one of a maximum and minimum intensity at the first location to the other of the maximum and minimum intensity at the intermediate location, and the intensity of the light which passes through the second part varying from one of a maximum and minimum intensity at the intermediate part to the other of the maximum and minimum at the second location.

Thus, according to this aspect of the invention, the relative amount of light which passes through the second part from the first location of the second part to the second location of the second part plotted against position of the second section from the first location to the second location, is of V or U-shaped configuration. The apex of the V or U thereby providing a minimum or maximum point which can be used to readily identify a reference location such as, in the case of a boat control, a neutral drive lever position. Because this position is at a maximum or minimum, any drift due to temperature or the like can be easily compensated for because the apex will always be a maximum or minimum, notwithstanding that the actual voltage level corresponding to the light intensity may change slightly with temperature fluctuation. Thus, the neutral position can always be easily ascertained. The amount of light which passes through the first section enables a determination to be made as to which side of the apex the light intensity reference is so that a control signal relative to the minimum or maximum can be generated. Thus, in terms of a boat controller, one side of the apex of the plot can relate to forward gear and the other side of the V or U-shape plot relative to the apex indicating reverse gear.

In the preferred embodiment of the invention the first part is longer than the second part. This provides greater sensitivity in the first part and in terms of a boat control, the first part can be used to indicate forward gear in which the boat will spend most of its time, thereby providing greater sensitivity and speed range in forward gear, than in reverse gear where the boat will spend less time and usually will be required to move much slower.

Preferably the screen element has a third section and the amount of light which can pass through the third section of the screen element varying from a first position of the third section to a second position of the third section.

Most preferably the third section is a mirror image of the first section.

Preferably the screen element comprises a variable translucency screen element so that light is able to pass through the screen element from the light emitter device to the light collector device.

Preferably the variable translucency of each section of the screen element is defined by a plurality of spaced apart bars of varying size which are perpendicular to the direction of relative movement between the screen element and the emitter device and collector device.

Most preferably the bars in the first section comprise groups of bars of different width, each group having a plurality of bars of the same width.

Preferably the first part of the second section comprises groups of bars with each group having a plurality of bars of a lesser number than those in the groups of the first section.

Preferably the second part of the second section comprises individual bars of varying width.

Preferably the screen element has a diffuser on both sides of the screen element.

Preferably the screen element is of cylindrical configuration.

Preferably the light emitter device comprises a separate light emitter for each of the sections of the screen element and the light collector device comprises a separate light collector for each section for collecting light from the corresponding light emitter.

Preferably the screen element is mounted for movement and the light emitter device and light collector device are stationary.

The present invention, in a second aspect, may be said to reside in a potentiometer comprising:
a light emitter device;
a light collector device;
a screen element located between the emitter device and collector device for movement relative to the emitter device and collector device; and
a plurality of bars on the screen element to provide varying translucency of the screen element, the plurality of bars being arranged in groups with each group having a plurality of individual bars of the same thickness, and the thickness of bars in respective groups of bars being different from one another.

Thus, according to this aspect of the invention, because groups of bars are provided with each group having bars of the same thickness, but the respective groups having bars of different thickness, a relatively long length of screen element can be provided within the confines of limitations provided by forming the bars on the screen element, to thereby provide greater sensitivity of the potentiometer. The greater sensitivity is achieved by enabling the length from a minimum thickness of the bars to a maximum thickness of the bars to be increased because of the plurality of bars in each group.

Preferably the screen element has at least a first section and a second section;
the first section allowing the amount of light which can pass through the first section to change from a first location of the first section to a second location of the first section; and
the second section having a first part and a second part, the first part allowing the amount of light which can pass through the first part to change from a first location of the second section to an intermediate location of the second section, and a second part in which the amount of light which can pass through the second part changes from the intermediate location to a second location of the second part, the change in the amount of light which can pass through the first part, varying from one of a maximum and minimum intensity at the first location to the other of the maximum and minimum at the intermediate location, and the intensity of the light which passes through the second part varying from the other of the maximum or minimum at the intermediate part to the other of the maximum and minimum at the second location.

Preferably the screen element has a third section and the amount of light which can pass through the third section of the screen element varying from a first position of the third section to a second position of the third section.

Most preferably the third section is a mirror image of the first section.

Preferably the bars are perpendicular to the direction of relative movement between the screen element and the emitter device and collector device.

Most preferably the bars in the first section comprise groups of bars of different width, each group having a plurality of bars of the same width.

Preferably the first part of the second section comprises groups of bars with each group having a plurality of bars of a lesser number than those in the groups of the first section.

Preferably the second part of the second section comprises individual bars of varying width.

Preferably the screen element has a diffuser on both sides of the screen element.

Preferably the screen element is of cylindrical configuration.

Preferably the light emitter device comprises a separate light emitter for each of the sections of the screen element and the light collector device comprises a separate light collector for each section for collecting light from the corresponding light emitter.

Preferably the screen element is mounted for movement and the light emitter device and light collector device are stationary.

The invention in a still further aspect may be said to reside in a potentiometer comprising:
a light emitter device;
a light collector device;
a screen element located between the light emitter device and the light collector device for movement relative to the light emitter device and light collector device; and
a diffuser for diffusing light before or after the light passes through the screen element.

This aspect of the invention results in a more consistent change of the amount of light which passes through the screen element, thereby overcoming slight irregularities in the intensity detected by the light collector, and therefore providing a better control signal from the potentiometer.

Preferably the light diffuser comprises a first diffuser element on one side of the screen element, and a second diffuser element on the other side of the screen element.

Preferably the first and second diffuser elements comprise a housing for retaining the screen element.

Preferably the screen element has at least a first section and a second section;
the first section allowing the amount of light which can pass through the first section to change from a first location of the first section to a second location of the first section; and
the second section having a first part and a second part, the first part allowing the amount of light which can pass through the first part to change from a first location of the second section to an intermediate location of the second section, and a second part in which the amount of light which can pass through the second part changes from the intermediate location to a second location of the second part, the change in the amount of light which can pass through the first part, varying from one of a maximum and minimum intensity at the first location to the other of the maximum and minimum at the intermediate location, and the intensity of the light which passes through the second part varying from the other of the maximum or minimum at the intermediate part to the other of the maximum and minimum at the second location.

In the preferred embodiment of the invention the first part is longer than the second part.

Preferably the screen element has a third section and the amount of light which can pass through the third section of the screen element varying from a first position of the third section to a second position of the third section.

Most preferably the third section is a mirror image of the first section.

Preferably the screen element comprises a variable translucency screen element so that light is able to pass through the screen element from the light emitter device to the light collector device.

Preferably the variable translucency of each section of the screen element is defined by a plurality of spaced apart bars of varying size which are perpendicular to the direction of relative movement between the screen element and the emitter device and collector device.

Most preferably the bars in the first section comprise groups of bars of different width, each group having a plurality of bars of the same width.

Preferably the first part of the second section comprises groups of bars with each group having a plurality of bars of a lesser number than those in the groups of the first section.

Preferably the second part of the second section comprises individual bars of varying width.

Preferably the screen element has an opaque cover on both sides of the screen element.

Preferably the screen element is of cylindrical configuration.

Preferably the light emitter device comprises a separate light emitter for each of the sections of the screen element and the light collector device comprises a separate light collector for each section for collecting light from the corresponding light emitter.

Preferably the screen element is mounted for movement and the light emitter device and light collector device are stationary.

### BRIEF DESCRIPTION OF THE DRAWINGS

A preferred embodiment of the invention will be described, by way of example, with reference to the accompanying drawings, in which:

FIG. 1 shows the layout of a screen element used in the preferred embodiment of the invention;

FIG. 2 is a graph of transmitted light intensity versus position in respect of the screen element described with reference to FIG. 1;

FIG. 3 is a view of an outer diffuser used in the preferred embodiment;

FIG. 4 is a view of the screen element of FIG. 1 formed into a cylindrical shape;

FIG. 5 is a view of an inner diffuser used in the preferred embodiment;

FIG. 6 is a view of a light emitter and collector arrangement used in the preferred embodiment;

FIG. 7 is a view of the assembled potentiometer; and

FIG. 8 is a view of the potentiometer associated with a control lever for a boat.

### DETAILED DESCRIPTION OF THE PREFERRED EMBODIMENT

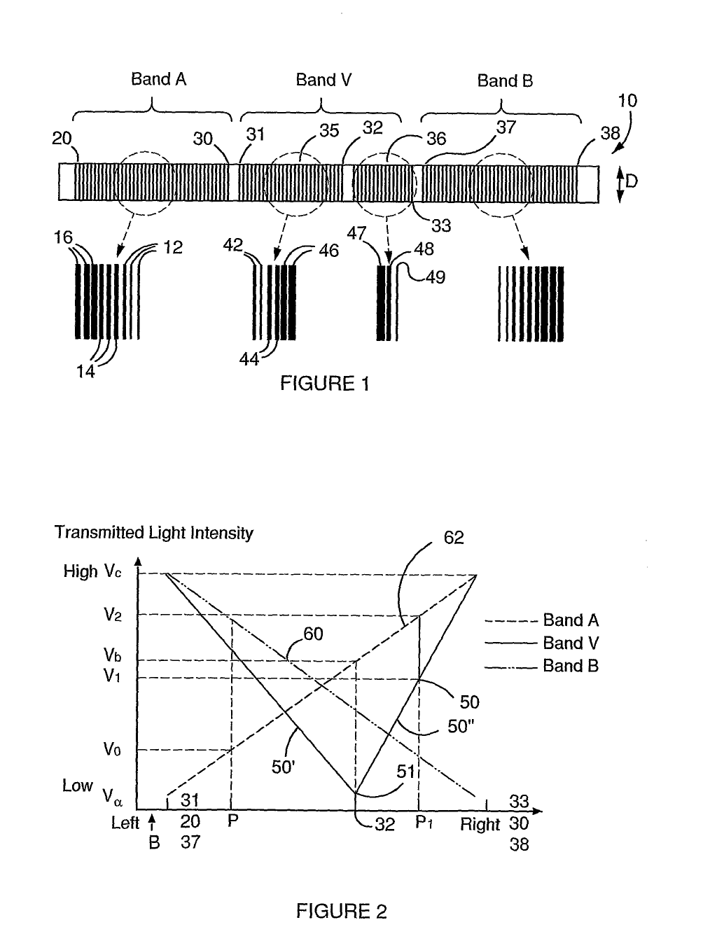

With reference to FIG. 1 a screen element 10 is shown which has a first section marked band A, a second section marked band V and a third section marked band B in FIG. 1. Each of the sections are provided with printed bars which are parallel with respect to one another and perpendicular to the direction of relative movement of the screen element 10 with respect to light emitters and collectors 92 which will be described with reference to FIGS. 6 and 7. Suffice it to say for the present purpose that in the preferred embodiment of the invention, one light emitter and one light collector is associated with each of the sections A, V and B as shown in FIG. 7. The parallel bars have centres which are spaced from one another by the same distance and are of different width to provide varying translucency because the space between edges of the bars will therefore decrease as the bars become thicker. Thus, the amount of light which is detected by the collector changes as the screen 10 moves relative to the emitters and collectors. The use of parallel bars as shown in FIG. 1 is advantageous because any movement of the screen element in the direction of double-headed arrow D in FIG. 1 relative to the light emitters and light collectors will have no consequence on the amount of light which is transmitted. Thus, any slight relative movement of parts of the potentiometer after assembly and in use will not create any errors because the movement will not alter the light intensity which passes through the screen element 10.

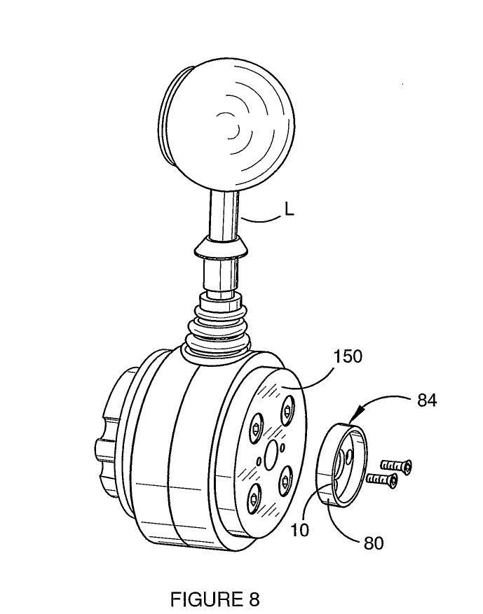

In the preferred embodiment of the invention, three sections are utilised so as to provide an output reference signal which can be used to show that a boat control lever L (see FIG. 8) is in neutral, or in forward gear to give a required forward speed, or in reverse gear to give a required reverse speed, as well as providing signals which can be used to distinguish between reverse and forward gear, and also providing some redundancy in case some of the light emitters or collectors should fail during operation.

In the preferred embodiment shown in FIG. 1, the section V provides the control signal to provide boat speed and to select neutral. The section A enables forward gear and reverse gear to be distinguished and the third section B provides for redundancy.

The first section A is formed from a plurality of groups of bars with each group having three bars of the same thickness. For example, in the enlarged circle part of section A shown in FIG. 1, there are three bars 12 of the same thickness, then three bars 14 of larger thickness and then three bars 16 of still larger thickness. Each of the bars 12 are of the same thickness, each of the bars 14 are of the same thickness, and each of the bars 16 are of the same thickness. The reason for providing multiple bars of the same thickness in each group 12, 14 and 16, etc. is to ensure that the length of the section from a first location 20 to a second location 30 can vary over a relatively long distance of the screen element 10 (for example 120°) when the screen element 10 is formed into a cylinder, as shown in FIG. 4.

In the preferred embodiment of the invention the bars 12 are formed by printing and the greatest sensitivity which can be provided is a bar of width 0.02 mm. The bars can then be increased in thickness by doubling that thickness. For example, the bars 12 may start at the second location 30 and be of 0.2 mm thickness, the bars 14 are of 0.04 mm thickness, the bars 16 of 0.06 mm thickness and so on from the position 30 to the position 20. If only a single bar 12, 14, 16 of one thickness is provided, the distance between the first and second locations 20 and 30 using the same graduation would be much smaller (and indeed, ⅓ the distance which is provided by using three bars of the same width in each group). The smaller distance would thereby greatly reduce sensitivity because light intensity change would go from a maximum to a minimum in a much smaller distance than if multiple bars of the same thickness are used as shown in FIG. 1.

Section V of the screen element 10 has a first part 35 and a second part 36. The first part 35 has a first location 31 and extends to an intermediate location 32 of the section V. The second part 36 extends from the intermediate location 32 to a second location 33. The first part 35 is formed in the same manner as the first section A, except that each group of bars comprises two bars, such as a first group of bars 42, a second group of bars 44, and a third group of bars 46, etc. The bars are formed of multiple thicknesses of 0.02 mm. The section V is the same length as the section A and also occupies 120° of the cylindrical screen element 10 shown in FIG. 4. However, because the groups of bars in the first part 35 comprise two bars instead of three bars, the length of the first group is effectively two thirds of the length of the section V. The second part 36 is formed of individual bars 47, 48 and 49 (for example) which increase in thickness by multiples of 0.02 mm and has a length of ⅓ of the section V.

As is shown in the enlarged detail in FIG. 1, the bars in the first part 35 increase from a minimum thickness at the first location 31 to a maximum thickness at the intermediate location 32. The bars in the second part 36 decrease from the maximum thickness at the intermediate location 32 to a minimum thickness at the second location 33.

As is shown in FIG. 2, when the screen element 10 moves relative to the light emitter and light collector, the light intensity transmitted through the screen element 10 from position 31 shown in FIG. 2 to position 33 changes in a V-shaped profile. Thus, the electric control signal which is provided from the collector is of V-shaped profile 50 as shown in FIG. 2. The apex 51 of the signal 50 is of course a minimum and therefore the apex which provides neutral position in the case of the boat control lever L, can always be determined because it is the minimum voltage signal from the light collector. Thus, even if the voltage change slightly because of changes in temperature or other fluctuations, the minimum voltage can always be determined as the lever moves between positions 31 and 33 so that neutral position can always reliably be obtained.

In an alternative embodiment, rather than having the maximum bar thickness at the intermediate position 32, the bars in the first part 35 and the second part 36 can be reversed so that the minimum thickness bars are at the intermediate position 32. This would mean that the V-shaped profile 50 is in effect inverted in shape to that shown in FIG. 2. Nevertheless, the same advantages are derived.

The third section B of the screen element 10 is a mirror image of the first section A, with the minimum bar thickness being at a first location 37 and the maximum bar thickness being at the second location 38. Once again, if desired, the location of the maximum thickness bars and minimum thickness bars in the sections A and B could be reversed to that shown in FIG. 1.

When light passes through the section A, a light intensity variation 60 shown in FIG. 2 is provided, and when light passes through the section B, a light intensity variation 62 shown in FIG. 2 is provided.

Thus, if the boat control lever L is moved to provide forward motion to in turn the screen element 10 relative to the respective light emitters and light collectors, to a position, for example P shown in FIG. 2, an output voltage V1 from the light collector associated with the section V is obtained. However, it is not possible to determine whether that voltage V1 corresponds to forward motion, which is the part of the trace 50 labelled 50′ in FIG. 2, or reverse motion which is the part of the trace 50″ in FIG. 2, because a lever position at P1 shown in FIG. 2 will also provide the same voltage output from the collector associated with section V. Thus, to determine whether the position of the lever is in fact P or P1, the voltage outputs from the light collectors associated with the section A or section B are considered. The voltage output V0 from the light collector associated with section A is matched with the voltage V1 to determine the part of the V-shaped trace that applies (in other words, forward gear is selected). For example, at position P, voltage V1 is matched with the voltage from the collector associated with band A and if that voltage is V0, then the system knows that the forward gear trace 50′ is that which applies. If the voltage was V2, then the reverse gear trace 50″ would apply. Thus, if the voltage V1 matches a voltage in the range Va to Vb, then forward gear and trace 50′ is applicable. If the voltage V1 matches a voltage of Vb to Vc, then the trace 50″ is applicable and reverse gear is that which is selected.

As is shown in FIGS. 1 and 2, the part 35 is greater than the part 36 so that more sensitivity is provided in forward gear where the boat will spend most of its time and usually require a greater speed range than reverse gear, where the boat will spend much less time and generally require much less speed range. However, if desired, the parts 35 and 36 could be the same size and, further still, if reverse gear is more important, the part 36 could be larger than the part 35.

The third section B provides redundancy in case the light emitter or collector associated with section A fails or, in fact, the light emitter or light collector associated with section V fails. The output signal from the light collector associated with section B can be used to determine which side of the apex 51 is involved, in the same manner as previously described. The light collectors associated with the sections A and B can also provide appropriate control if the light emitter or collector associated with section V fails, to enable the boat to be controlled in speed. The combination of the voltages from the collectors associated with sections A and B will enable a determination to be made as to whether reverse or forward gear is selected and the appropriate speed based on the levels of those voltages.

Thus, the preferred embodiment of the invention described with reference to FIGS. 1 and 2 provides considerable sensitivity to the control of the speed and the determination of whether forward or reverse gear has been selected, and also redundancy in case there is some failure in the light collectors or emitters or associated circuitry during use of the potentiometer.

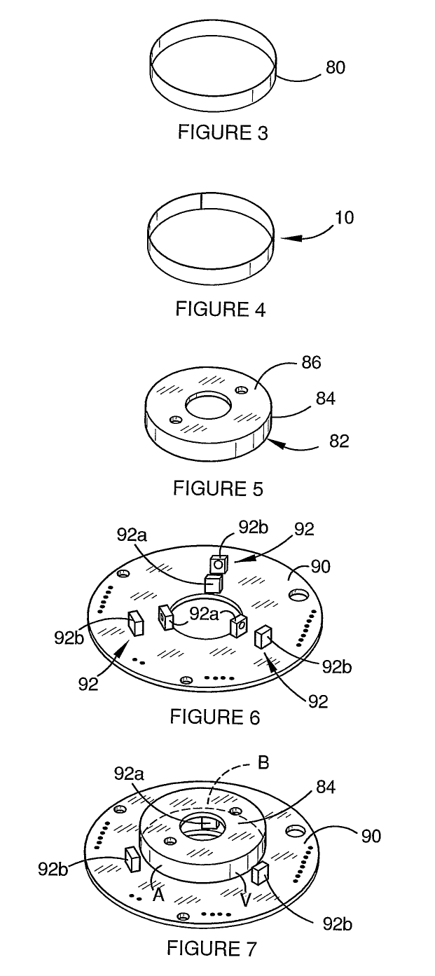

FIG. 3 to FIG. 7 show the assembly of the potentiometer according to the preferred embodiment. FIG. 3 shows an outer diffuser which simply comprises a transparent ring 80 which has been provided with a fusing surface so that light diffuses slightly as it passes through the diffuser 80. FIG. 4, as previously mentioned, shows the screen 10 of FIG. 1 formed into a cylindrical configuration.

FIG. 5 shows an inner diffuser 82 which is of cap-shaped design having a peripheral wall 84 and a top 86. The cylindrical strip 10 locates on the peripheral wall 84 and then the outer diffuser 80 locates over the strip 10. Thus, a diffuser is provided on both sides of the screen element 10 for diffusing light which passes through the screen element 10 so as to provide a more stable light variation and less irregularities or peaks and troughs in the output voltages from the respective light collectors.

FIG. 6 shows a circuit board 90 on which is mounted circuitry for operating the potentiometer, including three sets of light emitters and light collectors 92. Each set of light emitters and light collectors corresponds to one of the sections A, V and B shown in FIG. 1. The peripheral wall 84, with the screen element 10 and the outer diffuser 80, locates between respective light emitters 92a and light collectors 92b of each set 92.

As is shown in FIG. 8, the control lever L has a hub 150 and the diffuser 84 together with the screen element 10 and outer diffuser ring 80 bolts onto hub 150 for movement with the hub 150 under the control of the lever L. Thus, the screen element 10 is moved relative to the circuit board 90 (not shown in FIG. 8) which is fixed in a housing of the type shown in the aforementioned International application.

In alternative embodiments of the invention, rather than providing horizontal bars as shown in FIG. 1, the sections may include longitudinal stripes extending in the longitudinal direction of the screen element 10 in each section, which are of generally triangular shape, to thereby provide the varying translucency of the screen element 10. Still further, rather than providing a V-type output 50 from the section V, the output may be purely linear. Although this embodiment does not provide the advantage of the apex 51 to locate neutral, a reference voltage could still be assigned to neutral and the outputs from the collectors associated with the sections A and B could provide different bands of voltage levels for redundancy purposes and to monitor that the collector associated with the band V is operating properly.

In this specification it should be understood that the word “light” means electromagnetic radiation of any wavelength and not merely visible light.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1. A potentiometer comprising:
a light emitter device;
a light collector device;
a screen element located between the emitter device and collector device for movement relative to the emitter device and collector device;
the screen element having at least a first section and a second section;
the first section allowing the amount of light which can pass through the first section to change from a first location of the first section to a second location of the first section; and
the second section having a first part and a second part, the first part allowing the amount of light which can pass through the first part to change from a first location of the second section to an intermediate location of the second section, and the second part allowing the amount of light which can pass through the second part to change from the intermediate location to a second location of the second part, the change in the amount of light which can pass through the first part, varying from a first one of a maximum and minimum intensity at the first location to the other of the maximum and minimum intensity at the intermediate location, and the intensity of the light which passes through the second part varying from one of a maximum and minimum intensity at the intermediate part to the other of the maximum and minimum at the second location.

2. The potentiometer of claim 1 wherein the first part is longer than the second part.

3. The potentiometer of claim 1 wherein the screen element has a third section and the amount of light which can pass through the third section of the screen element varying from a first position of the third section to a second position of the third section.

4. The potentiometer of claim 3 wherein the third section is a mirror image of the first section.

5. The potentiometer of claim 1 wherein the screen element comprises a variable translucency screen element so that light is able to pass through the screen element from the light emitter device to the light collector device.

6. The potentiometer of claim 5 wherein the variable translucency of each section of the screen element is defined by a plurality of spaced apart bars of varying size which are perpendicular to the direction of relative movement between the screen element and the emitter device and collector device.

7. The potentiometer of claim 6 wherein the bars in the first section comprise groups of bars of different width, each group having a plurality of bars of the same width.

8. The potentiometer of claim 7 wherein the first part of the second section comprises groups of bars with each group having a plurality of bars of a lesser number than those in the groups of the first section.

9. The potentiometer of claim 7 wherein the second part of the second section comprises individual bars of varying width.

10. The potentiometer of claim 1 wherein the screen element has a diffuser on both sides of the screen element.

11. The potentiometer of claim 1 wherein the screen element is of cylindrical configuration.

12. The potentiometer of claim 1 wherein the light emitter device comprises a separate light emitter for each of the sections of the screen element and the light collector device comprises a separate light collector for each section for collecting light from the corresponding light emitter.

13. The potentiometer of claim 1 wherein the screen element is mounted for movement and the light emitter device and light collector device are stationary.

14. A potentiometer comprising:
a light emitter device;
a light collector device;
a screen element located between the emitter device and collector device for movement relative to the emitter device and collector device; and
a plurality of bars on the screen element to provide varying translucency of the screen element, the plurality of bars being arranged in groups with each group having a plurality of individual bars of the same thickness, and the thickness of bars in respective groups of bars being different from one another.

15. The potentiometer of claim 14 wherein the screen element has at least a first section and a second section;
the first section allowing the amount of light which can pass through the first section to change from a first location of the first section to a second location of the first section; and
the second section having a first part and a second part, the first part allowing the amount of light which can pass through the first part to change from a first location of the second section to an intermediate location of the second section, and a second part in which the amount of light which can pass through the second part changes from the intermediate location to a second location of the second part, the change in the amount of light which can pass through the first part, varying from one of a maximum and minimum intensity at the first location to the other of the maximum and minimum at the intermediate location, and the intensity of the light which passes through the second part varying from the other of the maximum or minimum at the intermediate part to the other of the maximum and minimum at the second location.

16. The potentiometer of claim 15 wherein the screen element has a third section and the amount of light which can pass through the third section of the screen element varying from a first position of the third section to a second position of the third section.

17. The potentiometer of claim 16 wherein the third section is a mirror image of the first section.

18. The potentiometer of claim 14 wherein the bars are perpendicular to the direction of relative movement between the screen element and the emitter device and collector device.

19. The potentiometer of claim 15 wherein the bars in the first section comprise groups of bars of different width, each group having a plurality of bars of the same width.

20. The potentiometer of claim 19 wherein the first part of the second section comprises groups of bars with each group having a plurality of bars of a lesser number than those in the groups of the first section.

21. The potentiometer of claim 15 wherein the second part of the second section comprises individual bars of varying width.

22. The potentiometer of claim 14 wherein the screen element has a diffuser on both sides of the screen element.

23. The potentiometer of claim 14 wherein the screen element is of cylindrical configuration.

24. The potentiometer of claim 14 wherein the light emitter device comprises a separate light emitter for each of the sections of the screen element and the light collector device comprises a separate light collector for each section for collecting light from the corresponding light emitter.

25. The potentiometer of claim 14 wherein the screen element is mounted for movement and the light emitter device and light collector device are stationary.

26. A potentiometer comprising:
a light emitter device;
a light collector device;
a screen element located between the light emitter device and the light collector device for movement relative to the light emitter device and light collector device; and
a diffuser for diffusing light before or after the light passes through the screen element.

27. The potentiometer of claim 26 wherein the light diffuser comprises a first diffuser element on one side of the screen element, and a second diffuser element on the other side of the screen element.

28. The potentiometer of claim 27 wherein the first and second diffuser elements comprise a housing for retaining the screen element.

29. The potentiometer of claim 26 wherein the screen element has at least a first section and a second section;
the first section allowing the amount of light which can pass through the first section to change from a first location of the first section to a second location of the first section; and
the second section having a first part and a second part, the first part allowing the amount of light which can pass through the first part to change from a first location of the second section to an intermediate location of the second section, and a second part in which the amount of light which can pass through the second part changes from the intermediate location to a second location of the second part, the change in the amount of light which can pass through the first part, varying from one of a maximum and minimum intensity at the first location to the other of the maximum and minimum at the intermediate location, and the intensity of the light which passes through the second part varying from the other of the maximum or minimum at the intermediate part to the other of the maximum and minimum at the second location.

30. The potentiometer of claim 29 wherein the first part is longer than the second part.

31. The potentiometer of claim 29 wherein the screen element has a third section and the amount of light which can pass through the third section of the screen element varying from a first position of the third section to a second position of the third section.

32. The potentiometer of claim 31 wherein the third section is a mirror image of the first section.

33. The potentiometer of claim 29 wherein the screen element comprises a variable translucency screen element so that light is able to pass through the screen element from the light emitter device to the light collector device.

34. The potentiometer of claim 33 wherein the variable translucency of each section of the screen element is defined by a plurality of spaced apart bars of varying size which are perpendicular to the direction of relative movement between the screen element and the emitter device and collector device.

35. The potentiometer of claim 29 wherein the bars in the first section comprise groups of bars of different width, each group having a plurality of bars of the same width.

36. The potentiometer of claim 29 wherein the first part of the second section comprises groups of bars with each group having a plurality of bars of a lesser number than those in the groups of the first section.

37. The potentiometer of claim 36 wherein the second part of the second section comprises individual bars of varying width.

38. The potentiometer of claim 26 wherein the screen element has an opaque cover on both sides of the screen element.

39. The potentiometer of claim 26 wherein the screen element is of cylindrical configuration.

40. The potentiometer of claim 26 wherein the light emitter device comprises a separate light emitter for each of the sections of the screen element and the light collector device comprises a separate light collector for each section for collecting light from the corresponding light emitter.

41. The potentiometer of claim 26 wherein the screen element is mounted for movement and the light emitter device and light collector device are stationary.
